(19) United States
(12) Patent Application Publication
(10) Pub. No.: US 2017/0071405 A1
(43) Pub. Date: Mar. 16, 2017

(54) Steam Lid

(71) Applicants: Lee Lisheng Huang, Palo Alto, CA (US); Timothy Funk, Thousand Oak, CA (US); Calvin Lin Huang, Palo Alto, CA (US)

(72) Inventors: Lee Lisheng Huang, Palo Alto, CA (US); Timothy Funk, Thousand Oak, CA (US); Calvin Lin Huang, Palo Alto, CA (US)

(21) Appl. No.: 14/854,892

(22) Filed: Sep. 15, 2015

(51) Int. Cl. A47J 37/10; A47J 27/04

(52) U.S. Cl. CPC A47J 37/103; A47J 27/04; A47J 2027/043

(57) ABSTRACT

A lid created with two opposing concave spaces so that one of them is used to cover food cooking on a griddle plate or in a cookware; the other concave space serves as liquid reservoir to store water; the water in the reservoir can drip to the griddle plate or the cookware to create steam for cooking food.

### FIELD OF THE INVENTION

The following disclosure relates to cooking utensil, the present invention teaches a convenient way to add steam to a griddle cooking via a metal lid.

### BACKGROUND

Griddle cooking is a major cooking method. A griddle is a typically a big flat metal plate where energy is fed to the metal plate by electricity or by gas combustion. Temperature of the metal plate is raised to 350-500 degrees Fahrenheit. Many different menus can be cooked on the griddle plate, such as burger, fish, eggs, vegetable etc. When cooking vegetables, pot stickers, or lobster tail for example, it is preferable to create some steam to aid in cooking. Usually chefs squirt water over the food using a water bottle and then cover the food with a lid. It is a messy, cumbersome process. Water must be squirted multiple times to cook cold items, especially if they have just been taken out from the refrigerator. It is the purpose of this patent to provide a steam lid that allows a more convenient way of generating steam.

### SUMMARY OF THE INVENTION

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

It is the purpose of this invention to ease the process of creating steam for griddle cooking, preferably to use a lid that can hold a certain amount of water to allow the gradual release water inside the lid to the griddle to create steam inside the lid.

It is an aspect of this invention to provide the design of such a steam lid to allow the water to transfer to inside of the lid.

It is an aspect of this invention to provide the design of such a steam lid to distribute water to generate steam at suitable locations inside the lid.

It is an aspect of this invention to provide a design of such a steam lid so that it can be manufactured cost effectively.

### BRIEF DESCRIPTION OF THE FIGURES

Objectives and advantages disclosed herein will be understood by reading the following detail description in conjunction with the drawing, in which:

FIG. 1 shows a perspective view of a steam lid sample.

FIG. 2 shows a side view of a steam lid sample.

FIG. 3 shows a perspective view of a steam lid sample.

FIG. 4 shows a side view of a steam lid sample.

FIG. 5 shows a perspective view of a steam lid sample.

FIG. 6 shows a side view of a steam lid sample.

FIG. 7 shows a perspective view of a steam lid sample.

FIG. 8 shows a side view of a steam lid sample.

FIG. 9 shows a perspective view of a steam lid sample.

FIG. 10 shows a side view of a steam lid sample

### DETAILED DESCRIPTION

Although the following detailed description contains many specifics for the purpose of illustration, anyone of ordinary skill in the art will readily appreciate that many variations and alterations to the following exemplary details may be made. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

Griddle cooking is a major cooking method. A griddle plate is typically a steel plate of approximately 15 mm thick, 500 mm wide, and 600 mm deep. The plate is heated by gas burners or electrical burners to temperatures of 350 to 550 degrees Fahrenheit. Food is placed on the hot surface to be cooked. It is preferable to put a lid to cover the food to reduce heat loss to speed up cooking. Sometimes it is preferred to generate steam inside the lid to speed up the cooking further for foods like vegetables, lobster tails, cheese on top of a burger, etc. It is a common practice to lift up the lid and spray water onto the griddle surface and then cover the steam with the lid. However, this is a cumbersome process, which leads to wasted steam and heat.

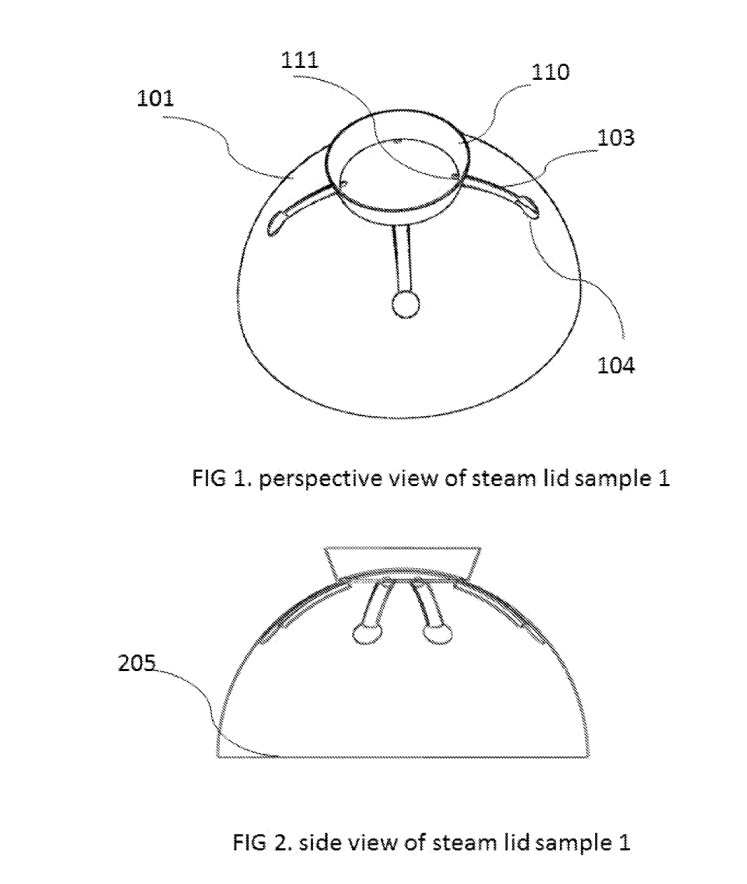

In the current invention, a new lid design is disclosed to allow steam to be generated inside the lid by putting water on top of the lid without lifting up the lid. FIG. 1, and FIG. 2 depict one embodiment of such design. The lid 101 is made of a piece of sheet material such as stainless steel, aluminum, glass, or ceramic formed in a dome shape. The downward facing concave space inside the dome allows food to be covered by the lid. The direction of the concave space is defined by the direction of the opening face of the concave space. The rim edge 205 of the dome is coplanar so that it can rest flush on a flat griddle surface. There are 4 grooves 103 formed by indentation on the dome. The grooves run radially, ending at 4 holes 104 on the wall of the dome. The holes 104 are through passages connecting the groove from the outside of the dome and the inside space of the dome. There is a cup 110 of sheet material attached on top of the dome. The cup has a concave space facing up as a liquid reservoir, and it serves as the handle of the steam lid as well. The cup can hold a certain volume of water, typically 230 milliliters. Water level markers can be marked on the wall of the cup to indicate the water volume at different level markers. The cup is attached to the dome by welding or by other fastening methods. There are four small holes 111 on the bottom of the cup at the perimeter of the bottom of the cup to allow water to be released from the reservoir. The holes 111 are positioned over the top end of the groove 103. The water can drip through the holes 111 into the groove 103. The water can flow along the groove to the holes 104 where it drips down to land on the hot griddle plate covered by the lid. The hot griddle plate will turn the water into steam inside the dome. As an example, the diameter of the steam lid edge is 240 mm, and the holes 104 are at about 20 mm from the edge of the steam lid. This leaves a cooking area of 200 mm in diameter for food inside the dome. The typical thickness of a stainless steel steam lid ranges from 0.5 mm to 2 mm. The diameter of the holes 111 is 2.5 mm and the diameter of holes 104 is 7 mm.

In operation, food is placed on a hot griddle. The lid is placed to cover the food. Water is added to the reservoir cup with, for example, a ladle. The water will drip from the cup 110 to the grooves 104. It flows along the grooves to drip through holes 104 to land on the griddle plate to create steam inside the concave space of the lid.

The cup can function as handle of the steam lid, however it could be too hot for hand to touch. The rim of the cup can be coated with thermal insulating materials such as silicone so that it is cool enough to touch. Alternatively, a handle with good thermal insulation is attached on the wall of the dome.

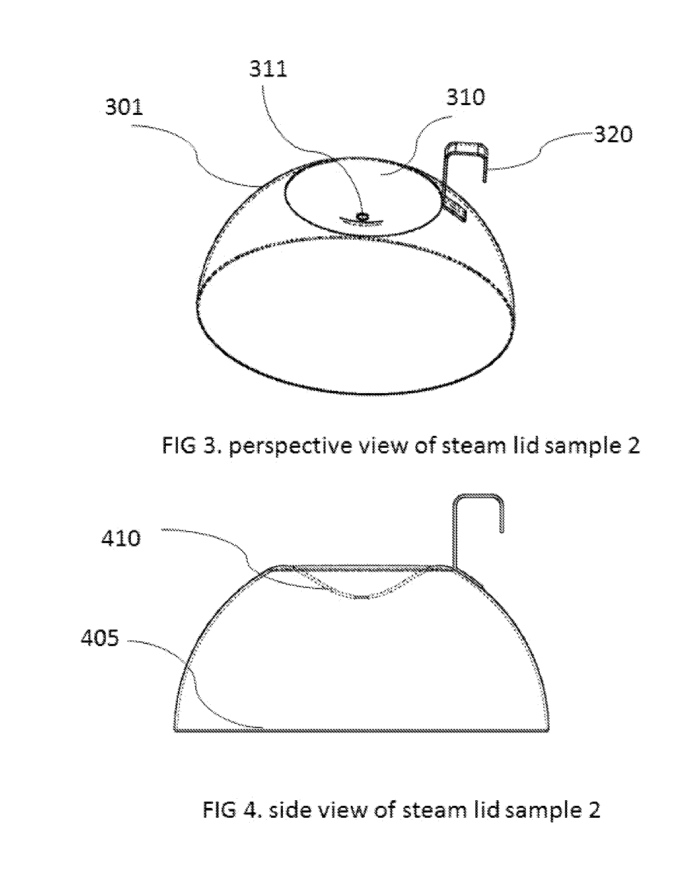

FIG. 3 and FIG. 4 show an alternative design where the reservoir 310 for the water is formed directly on the body of the lid 301. A lid 301 is a dome having a primary concave space facing downward and an upward facing secondary concave space 310 at the top of the dome. This concave space 310 can serve as liquid reservoir. There is a hole 311 at the bottom of the reservoir 310 to allow water to drip inside the dome to land on the griddle plate. The water drips on the center of the cooking area inside the steam lid in this case as compared with the case of FIG. 1 and FIG. 2 where the water drips onto the area 20 mm away from the edge of the steam lid. This requires different placement of the food inside the steam lid. The size of the hole 311 has a diameter of 2.5 mm. There is a handle 320 welded on the wall of the lid. The handle can be covered by a thermal insulating silicone or plastics layer so that it is cool to touch.

The edge of the lid 405 is conformed to a flat plate, and the reservoir space 410 is also indicated in FIG. 4.

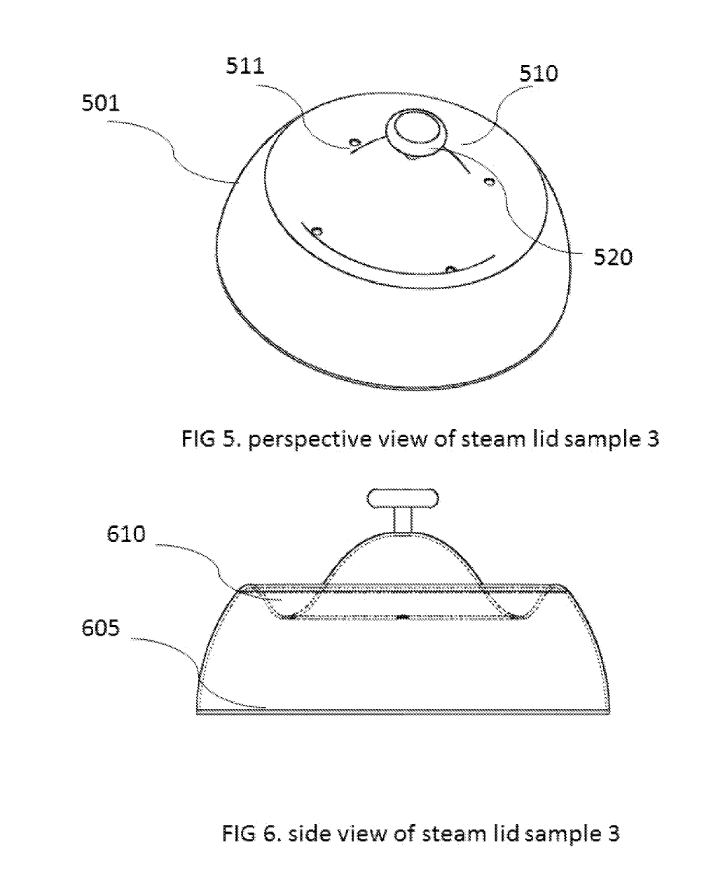

To offset the dripping location from the center, this design can be modified as in FIG. 5 and FIG. 6. The steam lid of 501 is formed firstly into a dome shape with a primary concave space facing downward. A ring shape secondary concave space 510 is formed on wall of the dome shape. Water can be stored in the ring shape reservoir. There are holes 511 on the bottom portion of the ring reservoir to allow water to drip to inside the dome. The diameter of the ring, therefore the distance of the holes from the edge of the steam lid, can be designed for particular applications. A lid handle 520 is attached to the top of the steam lid. FIG. 6 shows the sideway view of the design. 610 indicates the ring shape reservoir while 605 indicates the rim of the lid being conformed to a plane.

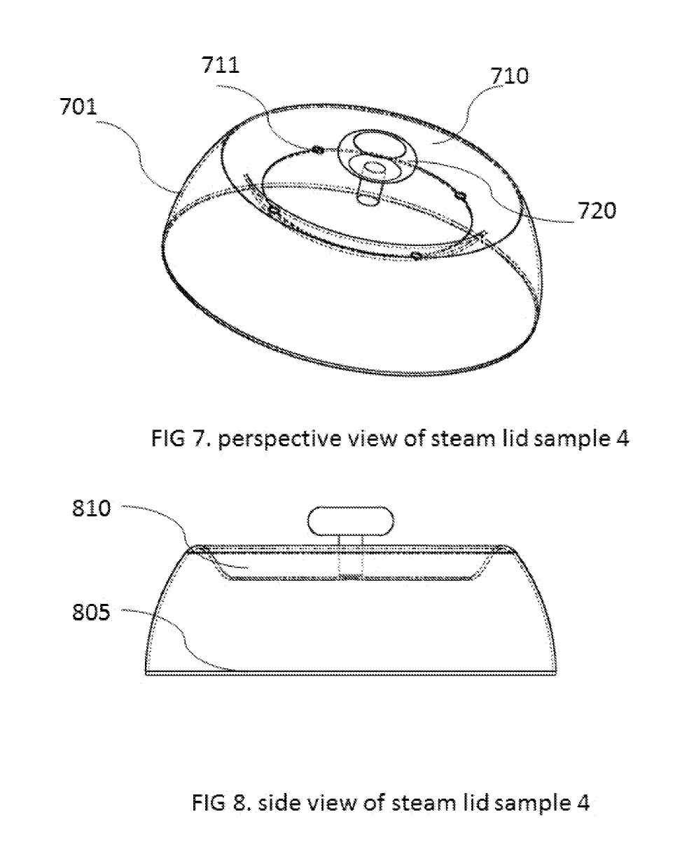

Flattening the bottom of the reservoir in the above example will result in an alternative embodiment shown in FIG. 7 and FIG. 8. As seen in the lid 701, the bottom of the liquid reservoir 710 is flat to have bigger volume than that in FIG. 5 and FIG. 6. Holes 711 are placed on the edge of the bottom of the reservoir. Alternatively, the hole can be in patterns on the bottom of the reservoir 710. Number of the holes, size of the holes can be design to specific applications. As an example, the diameter of hole 711 is 2.5 mm and there are 4 holes in the reservoir. FIG. 8 is a side view of the lid where the edge 805 will be in flash contact on a flat griddle plate. The reservoir 810 is shown to have a flat bottom. Ideally the bottom of the reservoir is slightly non-flat profiled in such a way that the holes are in the bottom region of the profile so that water will flow towards the holes in the reservoir.

The basic shape of steam lid can be different from a dome shape. For example, the wall of the lid can be in shape of a square, or a polygon.

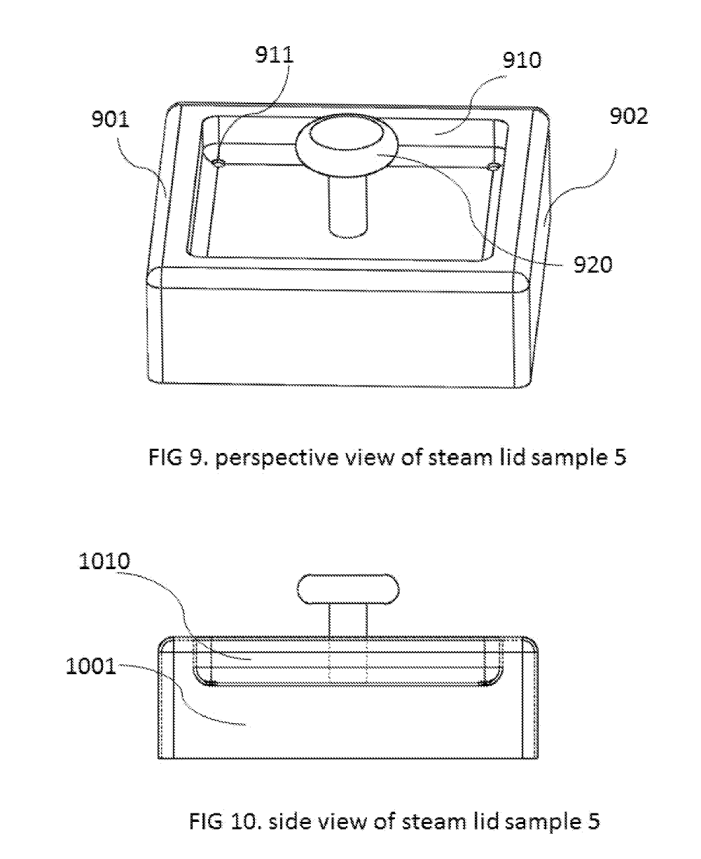

FIG. 9 and FIG show an example of a square lid. The steam lid 901 has a wall 902 in the shape of a square. The side of the square is of 250 mm. The wall 902 of the steam lid rises up vertically to a height of 50 mm forming a primary concave space facing downward. A reservoir 910 with a concave space facing upward is on the top of the steam lid. The reservoir 910 is a square shape as well, but it can be in the shape of a ring, a star or a polygon from a top view. Holes 911 are placed at the corners of the square of the reservoir to allow water to drip down to the hot plate under the lid. There is a handle 920 attached on the lid. The handle can be metal bar covered with a plastic or wooden round head. In FIG. 10, the steam lid 1001 is shown in side view, and reservoir 1011 is indicated.

The size of the reservoir is determined by certain parameters of the application it is targeted for, e.g. by the amount of steam needed, and the length of time the steam is needed. The number of hole and the size of the holes will determine the speed of the water to be release. It is possible to install a hole blocker that can be adjusted to allow different number of holes to open, or adjusting the size of the opening of a larger hole. As a product, the lid can be made with large number of holes half punched in production process, in such a way that a hole is not open yet, but it is very easy for a user to hand punch it open so that the user can decide how many holes to open for his application.

The steam lid of current invention can be for cooking on cookware as well. In a steam lid for such application, the wall height of the lid can be lower than that for the griddle cooking if the lid is design to rest on the wall of the cookware.

It is preferred to fabricate the steam dome using stamping, deep drawing, spinning, hydroforming and other sheet metal forming processes. For example, the design in FIG. 3 and FIG can be made using one-step stamping process using a mould. It can also be fabricated by casting, glass blowing processes, or other ceramic fabrication processes.

It will be appreciated to those skilled in the art that the preceding examples and are exemplary and not limiting. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

What is claimed is:

1. A Steam lid comprising:
a body having a primary concave space and an opposite facing liquid holding concave space;
a liquid passage connecting the two concave spaces;
in operation, the primary concave space covers food cooking on a hot surface while water in the liquid holding concave space traverses the liquid passage to the hot surface covered by the primary concave space to create steam inside the primary concave space.

2. The steam lid of claim 1 wherein the body having a primary concave space is a sheet material.

3. The steam lid of claim 2 wherein the liquid holding concave space is a cup attached to the sheet material.

4. The steam lid of claim 2 wherein both concave spaces are formed by a single sheet of metal.

5. The steam lid of claim 1 wherein said liquid passage includes a network of conduits distributing the water to a set of holes to allow dripping onto the hot surface at the locations away from where the food is cooking.

6. The steam lid comprising:
a body having said primary concave space and said opposite facing liquid holding concave space formed by a single piece of metal;
said liquid passage connecting said two concave spaces;
a handle attached to said single piece of metal;
in operation, said primary concave space covers food cooking on a hot surface while water in said liquid holding concave space traverses said liquid passage to said hot surface covered by said primary concave space thereby creating steam inside said primary concave space.

7. The steam lid of claim 6 wherein the opening of the concave space is a polygon shape.

8. The steam lid of claim 6 wherein said lid is a dome shape.

9. The steam lid of claim 6 wherein said lid is formed by stamping of a piece of sheet metal.

10. The steam lid of claim 6 wherein said lid is formed by casting.
